(19) United States
(12) Patent Application Publication
(10) Pub. No.: US 2017/0140682 A1
(43) Pub. Date: May 18, 2017

(54) Magnetic Bumper Attachment

(71) Applicant: Larry J. Borelli, New Paltz, NY (US)

(72) Inventor: Larry J. Borelli, New Paltz, NY (US)

(21) Appl. No.: 14/941,609

(22) Filed: Nov. 15, 2015

(51) Int. Cl. G09F 21/04

(52) U.S. Cl. CPC G09F 21/048; B60R 13/00

(57) ABSTRACT

In accordance with the present invention, a bumper sticker comprises an underlying magnetic substrate of an appropriate thickness together with magnetic indicia which, because of the thickness of the underlying magnetic substrate, are magnetically affixed to an object such as an automobile bumper or other vehicle portion. The present invention, the magnetic field lines of the magnetic indicia coupled to an object such as a vehicle bumper.

### CROSS-REFERENCE TO RELATED APPLICATIONS

This application contains subject matter which is related to the subject matter of the following application. The below listed application is hereby incorporated herein by reference in its entirety:

Provisional patent application No. 62/154,832.

### TECHNICAL FIELD

The present invention is generally directed to bumper attachments and, more particularly, to a magnetic alphabet bumper attachment. Even more particularly, the present invention is directed to a display device which provides users with the ability to create bumper stickers with customizable and individualized messages. While the description herein is couched in terms of message display on a vehicle bumper, the invention is not so limited but may be placed on any magnetic vehicle or other surface.

### BACKGROUND OF THE INVENTION

The use of bumper stickers is well known. Typically they are found on the rear bumpers of various vehicles including both personal vehicles and commercial vehicles. They provide a mechanism for expressing a point of view, for supporting political candidates, and for advertising amongst other things. They are typically attached to a vehicle in a permanent fashion using an adhesive backing. Once in place they are not removable nor are they changeable in terms of their content or position on the vehicle. Additionally, it is noted that bumper stickers of this variety are known to actually damage a car's surface.

There are, however, various forms of bumper stickers and other signs which are fixable to a vehicle via magnetism. These stickers and signs are typically attached to the sides of vehicles. However, the messages, insignias, logos, pictures, images thereon are not in any way adjustable or variable. In the employment of magnetic signs which are attached to vehicles, it is the case that other magnetic objects are not in fact attached to an underlying substrate. This situation would create a structure in which secondary objects magnetically affixed to the vehicle via the underlying substrate would not be held fast. Such secondary objects would be lost due to wind currents as a result of vehicle motion.

One of the significant problems associated with those magnetic bumper stickers which have additional magnetic characters attached thereto is that they may be blown off in the wind experienced by a moving vehicle. Furthermore, such bumper stickers or other advertising media, with movable magnetic characters, would not even be considered as usable since their placement on the side of a vehicle is highly problematical particularly when that vehicle is traveling at highway speeds. Common sense teaches that these indicia would simply be blown away. It is furthermore noted that this kind of message display device would also be subject to any number of environmental hazards including high humidity, scorching temperatures, rain, sleet, freezing rain, snow, ice and or other weather phenomena. Additionally, road conditions such as potholes and other examples of uneven road surfaces would cause vibration which also discourages the use of such message display devices.

There have been many attempts to create displays of visual material using movable or interchangeable magnetic letters. For example, the patent to Held (U.S. Pat. No. 6,338,214 issued Jan. 15, 2002) appears to disclose a system for producing traffic control signage. However, this patent appears to limit itself to a single magnetic material. The primary object of the patent to Held is the production of roadway warning signs at (transportation) construction sites. It is noted that a ferrous material is not same as a magnetic material. Ferrous materials, in particular, do not possess their own magnetic fields independently of other surrounding objects.

One of the more relevant patent applications, lying in the same general art area as the present invention, is found in U.S. Patent Application No. 2005/0155265 A1 published on Jul. 21, 2005. This is a patent to an easily modifiable magnetic sign published in the name Coleman-Chang. This patent speaks of an underlying board as being magnetic and the letters which are to be affixed thereto as also being magnetic. However, it is to be particularly noted that this particular patent application is directed primarily to signs used in real estate advertising. The signs herein are in no sense available for use as bumper stickers. This patent also asserts that there are many means for accomplishing the attachment of the letters. There is no particular focus on the use of magnetic materials. This applicant would just as likely use a Velcro® fastener. Furthermore, it is seen that there is nothing in this patent which would indicate that the signage produced is intended to be affixed to a vehicle. And most notably, this particular patent is devoid of any teachings with respect to the thickness or thinness of any underlying magnetic material.

Attention may also be directed to the patent to Rellinger (U.S. Pat. No. 5,913,615 issued Jun. 22, 1999). This patent also seeks to provide message display signage but only through the use of individual placards. It is these placards which contained a message and this is not a message which is in any way changeable or adaptable by the user.

The patent to Collie (U.S. Pat. No. 4,995,186 issued Feb. 26, 1991) appears to describe an inflatable sign which may be attached to a car as a mechanism to indicate that it is disabled. Likewise, the patent to Jones (U.S. Pat. No. 4,888,893 issued Dec. 26, 1989) appears to describe a roadside distress sign which may be attached to a vehicle which may have run out of gas.

The patent to Faggiano (U.S. Pat. No. 4,852,284 issued Aug. 1, 1989) appears to describe a side using magnets. However, any variation in signage display is accomplished by means of a slidable panel, not in any way by movable individual letters.

The patent to Galajda (U.S. Pat. No. 4,274,459 issued Jun. 23, 1981) appears to use magnetic strips to hold a metal template in a woodworking device used to form individual characters.

The patent application of Petrocy (U.S. Patent Application No. 2007/0094902 A1 published on May 3, 2007) appears to use letters having magnetic backing for a fixation to a wall or building. The overall sign structure is affixed to the building or wall by standard fasteners. Dual layers of magnetic material are neither employed nor contemplated.

The published patent application of Hudgins (2004/0016160 published on Jan. 29, 2004) is interesting in that it describes a kid for enabling one to create personalized bumper sticker messages. However, Hudgins relies on the use of an erasable surface. Hudgins further teaches that when in indelible ink is used for the writing, the bumper sticker must be replaced with a new one.

Issued U.S. Pat. No. 6,643,965 issued on Nov. 11, 2003 to Toraby-Payhan appears to describe a system for displaying titles on a movie marquee or for displaying varying prices at a gasoline station. While the devices shown therein appear to employee a magnetic attachment system, the numeric and alphabetic characters used in this system are sufficiently large and heavy so as to also require some form of mechanical hook.

Issued U.S. Pat. No. 5,813,154 issued on Sep. 28, 1998 to Wilford appears to describe a magnetic sign kit. This kit employs individual interlocking characters whose widths and heights are a function of individual character size. In particular, it appears that Wilford is attempting to deal with character sets that are not mono-spaced. Furthermore, Wilford teaches that his signage is disposed in a single layer. Wilford makes no distinction between holding characters in place magnetically or through the use of interlocking jigsaw pieces.

Accordingly, it is seen that an important aspect of the present invention lies in the fact that there are two magnetic layers involved. It is also an important aspect of the present invention that the magnetic substrate on which magnetic characters are disposed is sufficiently thin so that the characters themselves are magnetically attached not only to the magnetic substrate were also to an underlying ferrous body.

In short, there is no mechanism in any of the art cited above for an individual to be able to provide customizable message displays for a bumper sticker or other vehicle message display.

From the above, it is therefore seen that there exists a need in the art to overcome the deficiencies and limitations described herein and above.

### SUMMARY OF THE INVENTION

The shortcomings of the prior art are overcome and additional advantages are provided through the utilization of an underlying magnetic substrate which is of sufficient thinness to allow the passage therethrough of a magnetic field provided by one or more instances of an attachable character, a set of characters or other indicia. These are the secondary objects referred to above. In accordance with the present invention, references herein to a character include characters in any language including languages with ideograms and their associated punctuation and/or other diacritical marks. Furthermore, references herein to “messages” include messages which are communicated both textually and pictorially. In particular, it is noted that the present invention provides a system and method for user customization of a device such as a bumper sticker. Moreover, the system and method of the present invention are unique in that they produce a bumper sticker having interchangeable characters and messages selected in accordance with the desires of a user.

In accordance with a preferred embodiment of the present invention a device for displaying messages on a magnetically susceptible surface comprises a magnetic substrate for affixation to the surface and a plurality of magnetic indicia. Most importantly for the present invention, the magnetic substrate is sufficiently thin to allow magnetic attachment of said indicia to an underlying magnetically susceptible surface. In other words, in the present invention, the secondary objects referred to above are also magnetically attached, not just to the underlying magnetic substrate on which they are disposed, but they are also magnetically attached to the surface to which the substrate is affixed. Put another way, if the letter “A” is attached to the magnetically susceptible surface, this surface is thin enough to allow the magnetic field from the character “A” to pass through the magnetically susceptible surface which is itself attached to (in most cases) a ferrous portion of a vehicle.

An important feature of the present invention is the thickness of the underlying magnetic substrate which is intended to support the secondary objects referred to herein. Without this qualification, secondary objects affixed to a bumper sticker would be blown off by the aerodynamic effects created by a moving vehicle, especially at highway speeds. Accordingly, individuals working in the magnetic sign arts would not be led to employ such a structure because of this significant limitation. However, by making the underlying substrate sufficiently thin, the magnetic secondary objects thus become fixed to the underlying vehicle and not just to the underlying magnetic substrate to which they are most closely in contact.

Accordingly, it is an object of the present invention to provide a bumper sticker who is visible contents are chosen by a vehicle owner or user.

It is another object of the present invention to provide a bumper sticker whose contents can be varied.

It is yet another object of the present invention to provide a method for affixing magnetic materials to a ferrous substrate in a manner which reduces the effect that air motion has on their ability to remain fixed.

It is a still further object of the present invention to provide an advertising device for use with a vehicle.

It is still another object of the present invention to provide a device for facilitating ease of expression.

Lastly, but not limited hereto, it is an even further object of the present invention to provide a device, such as a bumper sticker, which can readily be removed from a vehicle without affecting a message that is displayed.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 illustrates a bumper sticker, constructed in accordance with the present invention and displaying the particular message “EXPRESS YOURSELF HERE.”

FIG. 2 constitutes a sample display of some of the alphabetic and punctuation characters that may be employed in conjunction with the present invention.

### DETAILED DESCRIPTION

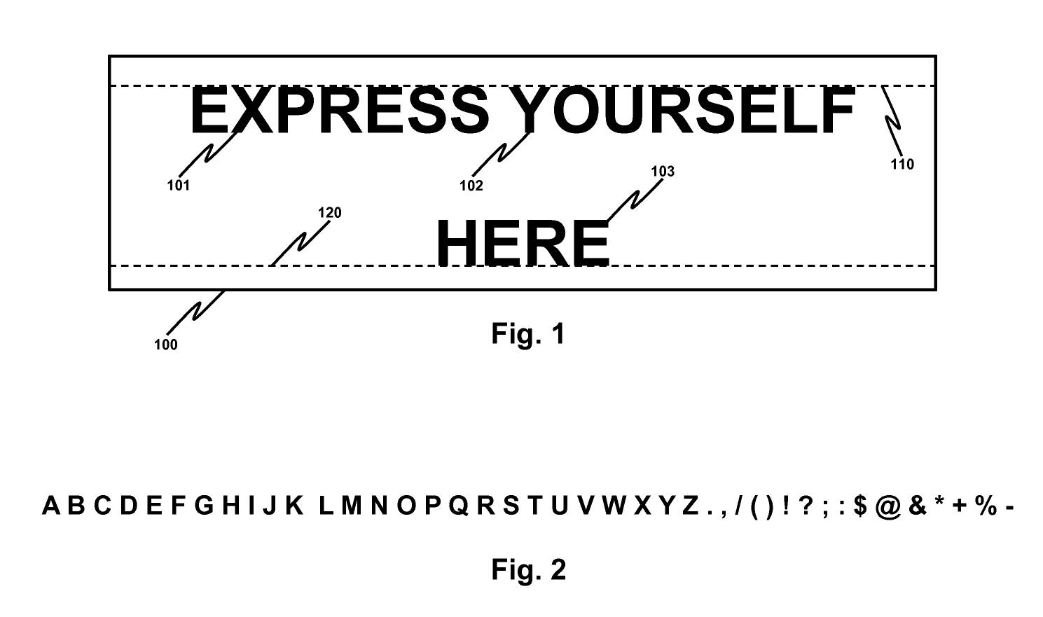

In preferred embodiments of the present invention, the underlying magnetic substrate for the bumper stickers is cut from a roll of thin magnetic stock that is composed of ferrite powder. The stock for the bumper sticker substrate is preferably about 0.02″ in thickness. This is a critical dimension that is, unfortunately, not visible in FIG. 1, for obvious reasons. However, the notion of “thickness” of an underlying substrate is an unambiguous concept. Similarly, letters, numerals, and punctuation marks (and generally the secondary objects referred to above) are cut from similar stock. However, this latter stock is preferably about 0.03″ in thickness. The text or other pictorial information present on the underlying magnetic substrate is changeable at will. This is done by changing the magnetic letters, numerals, punctuation, characters or pictorial objects in accordance with the user's desires or needs. These secondary objects are movable on and removable from the underlying magnetic substrate. However, and importantly for an understanding of the present invention the underlying magnetic substrate is sufficiently thin that the magnetic properties of the secondary objects allow these objects themselves to also be magnetically attached to the vehicle.

While preferred embodiments of the present invention employ underlying magnetic substrate having a thickness less than 0.02 inches, certain environments (for example, indoors) present themselves with the opportunity to employ thicker underlying magnetic substrates. The relevant factor is the ability of the magnetic field of the movable magnetic letters (generally, indicia) to penetrate the underlying magnetic substrate so as to be able to create a magnetic attachment between the magnetic surface (for example, car door) to which the underlying magnetic substrate is to be attached. Likewise, variation in thickness for the movable magnetic letters is also possible without departing from the inventive aspects described herein. The relevant factor in this choice is providing sufficient magnetic material to produce sufficient magnetic coupling through the all the way through to the object to which it is to be attached.

The present invention includes a ruled magnetic bumper sticker kit that includes interchangeable letters, numbers, and punctuations in English, Spanish or any desired language. By using this magnetic bumper sticker with interchangeable magnetic letters, numerals, and punctuation marks, one can change both position and content.

It is noted that since the present invention is easily affixed to a ferrous portion of a vehicle, it is just as easily removed. Advantageously for the present invention this removal is accomplished without any damage to the underlying vehicle finish. However, it should be noted that certain content might not be welcome viewing for all readers. Such individuals might be tempted to change the content expressed. Such individuals might also be tempted to remove this bumper sticker themselves and possibly to depart with it. Accordingly, users of the present invention are advised to remove it from their vehicle in those situations where interference with the content of the expression is suspected to occur. It is to be particularly noted that the present invention provides an advantage in that removal of the bumper sticker may be accomplished without disturbing the pattern of secondary object placed thereon.

In accordance with preferred embodiments of the present invention it is provided in the form of a magnetic bumper sticker kit. This kit comprises at least one substrate and a plurality of secondary objects for attachment thereto. Typically such a kit comprises one or more underlying magnetic substrates together with a mixture of alphabetic characters occurring in a frequency which is consistent with the language of the user. For example, with the English language the characters “E, T, A, O, I and N” are the most frequently employed. The well-known word board game Scrabble® provides a good indication of desirable letter frequency. The kit is conveniently packaged in a box sized to hold the underlying magnetic substrate and a plurality of characters. A sample set of such characters for the English language is shown in FIG. 2.

Referring now to FIG. 1, magnetic bumper sticker 100 is placeable on a car or any ferrous surface. The magnetic letters (for example, letters X, Y, and E, numerals 101, 102 and 103 respectively), or other secondary objects are arranged in any order to display any message. For convenience, lightly dashed rulings 110 and 120, as shown, are preferably placed on the underlying magnetic substrate for purposes of more easily aligning a set of characters. The characters may comprise any letters, in any font, or any size with the most desirable quality being readability. The magnetic bumper sticker is placed on any metal part of one's car. In preferred embodiments of the present invention the underlying magnetic substrate is first applied to the vehicle and then the secondary objects are affixed thereto to form any desired message or image. The underlying magnetic substrate is preferably flexible, particularly in those contexts where it is required to more closely conform to the curves of a vehicle on which it is to be disposed.

The magnetic substrate employed herein for affixation to a vehicle surface along with the magnetic indicia may be made of a material comprising any desired color. Clearly, it is not desirable that they be of the same color but rather of contrasting colors for ease of visibility. In particular, neon colors may be employed as well as substrate or indicia material that include reflective coatings or surfaces, for example, for ease of viewing at night time or at other periods of lesser visibility. Magnetic substrate and the magnetic indicia employed herein may be of any desired height consistent with vehicle placement. For example, substrate and indicia in accordance with the present invention may assume larger sizes when placed on a vehicle side doors as opposed to vehicle bumpers or to their rear trunk lids or other rear parts. It is noted that the message display device of the present invention my even be disposed on the sides of vehicles without being adversely affected by wind conditions, even at highway speeds.

In addition to the display device of the present invention, there is associated therewith a corresponding method. This is a method for attaching message display devices to an underlying surface which is susceptible to magnetic materials. The first step in this method is to provide an underlying magnetic substrate which is of sufficient thinness. The second step of the method is to provide magnetic indicia having a sufficiently strong magnetic field to penetrate the underlying magnetic substrate surface and to thus form a magnetic linkage with the object to which the message device is to be attached.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC §112, sixth paragraph, unless the element is expressly recited using the phrase “means for.”

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

1. A device for attachment to an external, magnetically susceptible surface of a motor vehicle, said device comprising:
a magnetic substrate for affixation to said external, magnetically susceptible motor vehicle surface; and
a plurality of magnetic indicia disposed on said substrate, said magnetic substrate being sufficiently thin to allow magnetic attachment of said magnetic indicia directly to said external magnetically susceptible motor vehicle surface.

2. The device of claim 1 in which said magnetic indicia comprise language elements selected from the group consisting of numbers, alphabetic characters and punctuation marks.

3. The device of claim 1 in which said indicia comprise language elements from an alphabet.

4. The device of claim 1 in which said magnetic substrate comprises a sheet of powdered ferrite.

5. The device of claim 1 in which said magnetic indicia comprise material made from a sheet of powdered ferrite.

6. The device of claim 1 in which said magnetic substrate is no more than 0.02 inches thick.

7. The device of claim 1 in which said magnetic indicia is approximately 0.03 inches thick.

8. The device of claim 1 in which said magnetic indicia is pictorial.

9. The device of claim 1 in combination with an external, magnetically susceptible surface of a motor vehicle.
